(19) United States
(12) Patent Application Publication
(10) Pub. No.: US 2013/0008851 A1
(43) Pub. Date: Jan. 10, 2013

(54) CATCH BASIN INSERT

(76) Inventors: Ernest Jarvis, JR., Norco, CA (US); Rafael Roy Padilla, Yucaipa, CA (US)

(21) Appl. No.: 13/353,570

(22) Filed: Jan. 19, 2012

Related U.S. Application Data
(63) Continuation-in-part of application No. 13/178,751, filed on Jul. 8, 2011.

(51) Int. Cl. B01D 35/28

(52) U.S. Cl. 210/499

(57) ABSTRACT

A screen system having a body with a screen having an upper edge, a lower edge and two side edges; a plurality of support rods coupled to the screen; mounting brackets coupled to the side edges of the screen; a plurality of bypass support members coupled to the screen; and a top coupled to the plurality of bypass support members.

### BACKGROUND OF THE INVENTION

This invention relates generally to storm drain system catch basins, and more particularly, to screen systems for installation in storm drain system catch basins.

The storm drain system is a vast network of underground pipes and open channels that were designed to prevent flooding of city streets. Rain water and ground water runoff drains from the street into a gutter and enters the storm drain system through an opening in the curb called a storm drain inlet. Typically, the storm drain inlet allows water to run into a catch basin from the street. Catch basins typically have an opening and an outlet pipe that provides a path for the water to run from the catch basin to the remainder of the storm drain system. The water then typically runs to a receiving water body.

In addition to runoff, trash and debris can enter the catch basins through the storm drain inlet. Many conventional catch basins have no means for filtering out the debris before the debris passes through the catch basin and runs into the remainder of the storm drain system and on to the receiving water body. This can result in street debris and trash making its way to and polluting the receiving water body.

Accordingly, there is a need for an improved means for filtering out debris that enters a catch basin before the debris makes its way into the remainder of the storm drain system.

### SUMMARY OF INVENTION

The present invention satisfies this need. The invention is a screen system for placement inside a catch basin. The screen system permits water to flow therethrough and prevents solid objects of predetermined size and shape from passing therethrough into an outlet of a storm drain catch basin. In an embodiment of the present invention, the screen system comprises a body comprising: a screen having an upper edge, a lower edge and two side edges; a plurality of support rods coupled to the screen; mounting brackets coupled to the side edges of the screen; a plurality of bypass support members coupled to the screen; and a top coupled to the plurality of bypass support members. In an alternative embodiment, a plurality of horizontal supports are coupled to the screen. Optionally, the mounting brackets each have a flange and the flange further comprises at least one mounting hole for mounting the screen system to the wall of a catch basin. The mounting holes may be keyhole shaped. At least two of the bypass support members may further comprise a flange, the flange having at least one mounting hole for mounting the screen system to the wall of a catch basin. The top may also have a screen.

In an embodiment, the top further comprises an opening and a door rotatably mounted therein, the door being moveable between a closed position and an open position. Optionally, the door may be rotated more than 90 degrees relative to the top. The moveable door may be configured to remain in the open position unless moved by hand. Optionally, the door further comprises a lock to hold the door in the closed position.

In an embodiment, the door has a front, a rear and two sides, each door side further comprising a flange with a pivot pin coupled thereto; the opening has a front, a rear and two sides, each opening side further comprising a flange with a pivot hole therein; and wherein the pivot pins are mounted in the pivot holes to rotatably couple the door to the top. The top may have a stop for limiting rotation of the door relative to the top. In an embodiment, the door has a plurality of protrusions and the front of the top opening has a plurality of detents, the protrusions and detents being configured to maintain the inner frame in a closed position.

In an embodiment, the screen system has a plurality of extensions moveably coupled to the screen, the extensions having a plurality of holes. At least one of the extensions may have an angled portion and the screen system configured for placement in a catch basin having a sloping floor. At least one of the extensions may have a rounded portion and the screen system is configured for placement in a catch basin having a rounded floor.

In an embodiment, the body is substantially U-shaped and has at least four bypass support members. In an alternative embodiment, the body is substantially L-shaped and has at least three bypass support members.

### BRIEF DESCRIPTION OF THE DRAWINGS

The features, aspects and advantages of the present invention will become better understood with regard to the following description, appended claims and accompanying figures wherein:

FIG. 1 is a perspective view of a catch basin insert according to an embodiment of the present invention installed in a typical catch basin;

FIG. 2 is an outside perspective view of a catch basin insert according to a first embodiment of the present invention;

FIG. 3 is an inside perspective view of a body of the catch basin insert of FIG. 2;

FIG. 4 is a perspective view of a door of the catch basin insert of FIG. 2;

FIG. 5 is a perspective view of a top of the catch basin of FIG. 2 with the door removed;

FIG. 6A is a perspective elevation view of a side bypass support member;

FIG. 6B is a perspective elevation view of a bypass support member;

FIG. 7 is an outside perspective view of a catch basin insert according to a second embodiment of the present invention; and

FIG. 8 is an inside perspective view of a body of a catch basin according to an alternative embodiment of the present invention.

### DETAILED DESCRIPTION OF THE PREFERRED EMBODIMENTS

In the following description of the preferred embodiments, reference is made to the accompanying drawings which show by way of illustration specific embodiments in which the invention may be practiced. Wherever possible, the same reference numbers will be used throughout the drawings to refer to the same or like parts. It is to be understood that other embodiments may be utilized and structural and functional changes may be made without departing from the scope of the present invention.

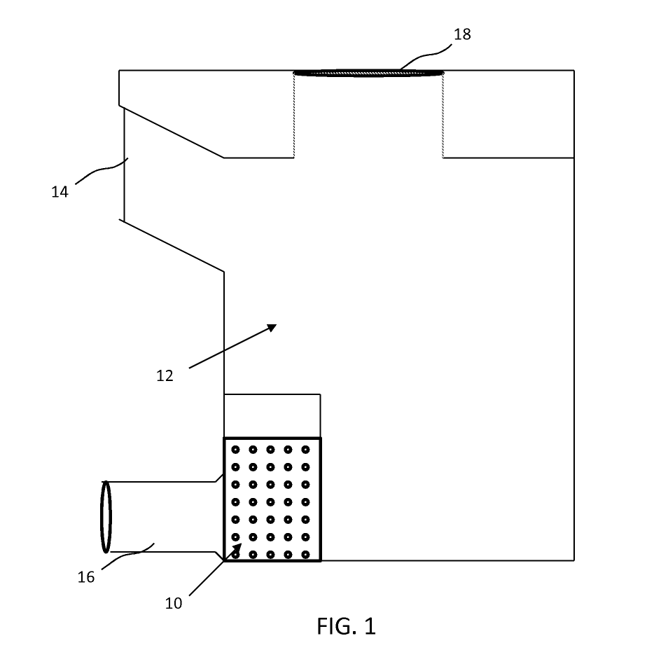

The present invention is an insert for a catch basin. FIG. 1 illustrates a first embodiment of the catch basin insert 10 of the present invention installed inside a conventional storm drain catch basin 12. The conventional storm drain basin 12 has a storm drain inlet 14 and an outlet pipe 16. A manhole 18 may be present to provide access to the storm drain catch basin. Preferably, the catch basin insert 10 is positioned adjacent the outlet pipe 16. However, the catch basin insert 10 may also be positioned adjacent the inlet 14 or at some other point between the insert 14 and the outlet pipe 16.

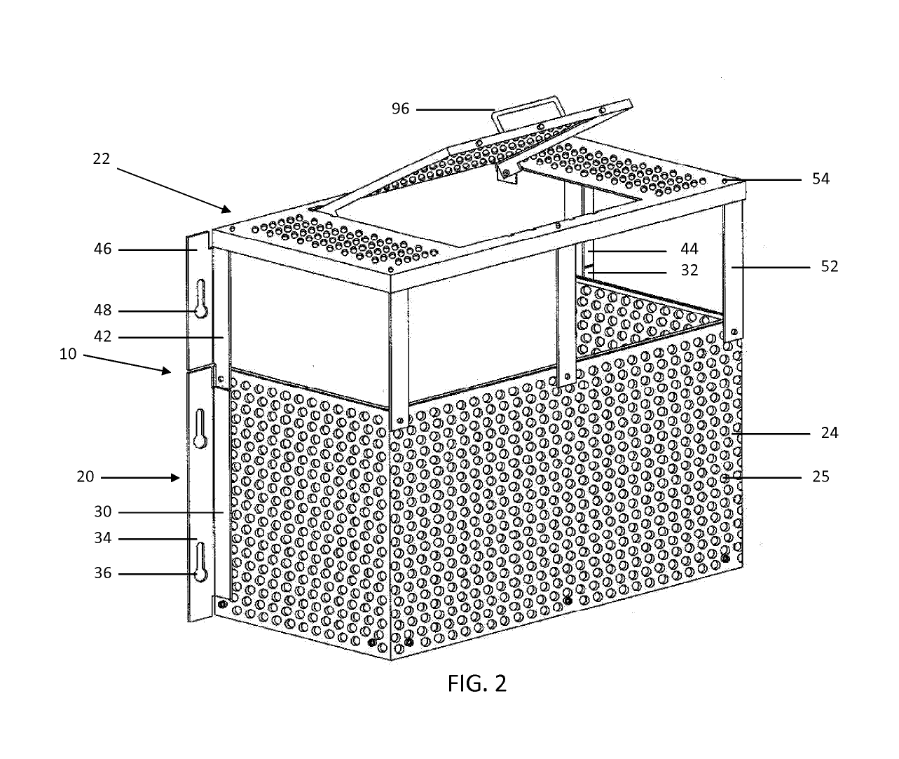

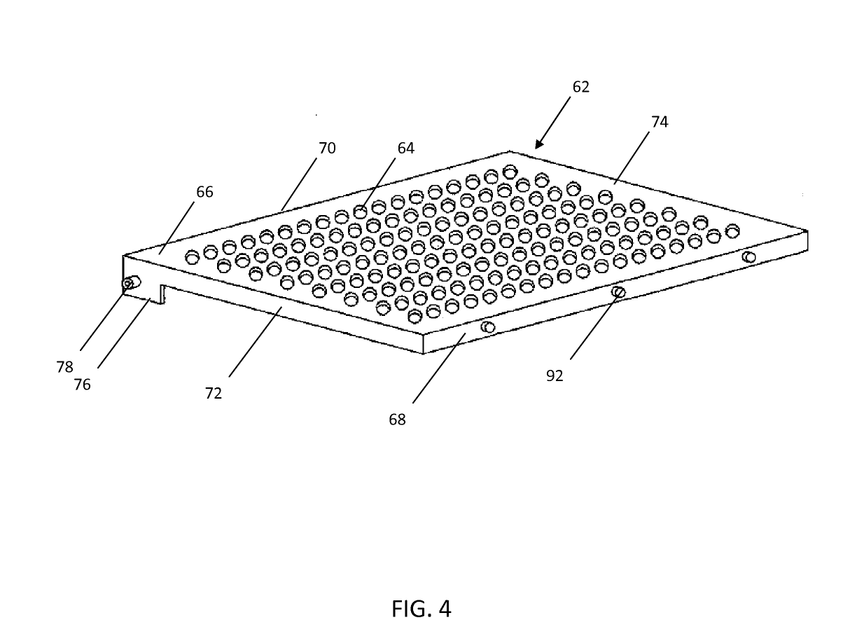

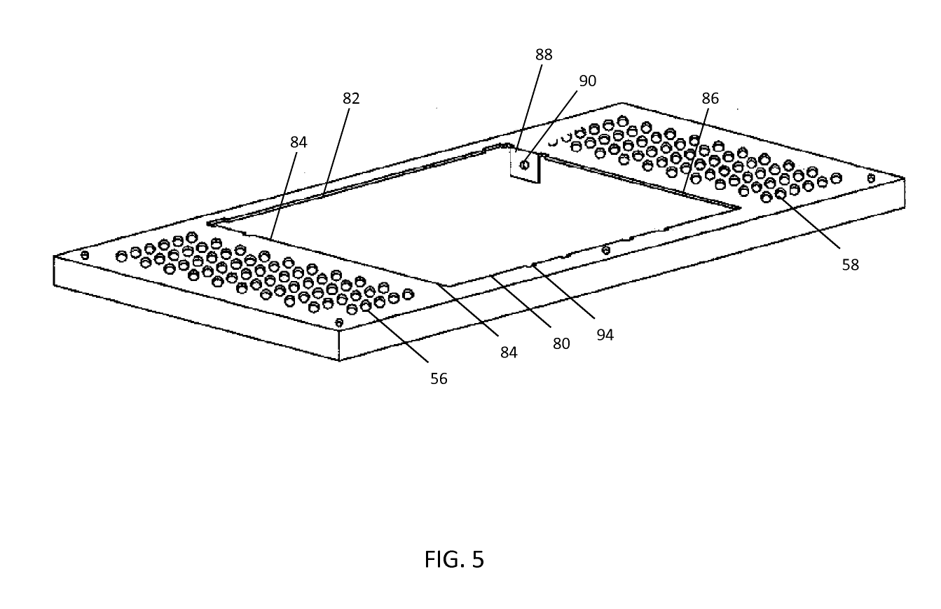

A first embodiment of the present invention will now be described in more detail with reference to FIGS. 2 to 6. FIG. 2 shows a perspective view of the first embodiment of the catch basin insert 10 of the present invention. The catch basin insert 10 has a body 20 and a top 22. The body 20 is substantially u-shaped and the top 22 is substantially rectangular, such as for mounting along a single wall. The body 20 has a screen 24. Preferably, the screen 24 is formed from stainless steel and has a plurality of holes 25. In an embodiment, the screen 24 is formed from 14 gauge stainless steel with a plurality of 5 mm holes 25. The size, number and pattern of holes 25 may be altered based on the environment of the catch basin, including for example, the expected volume of water and the size of expected debris in the water.

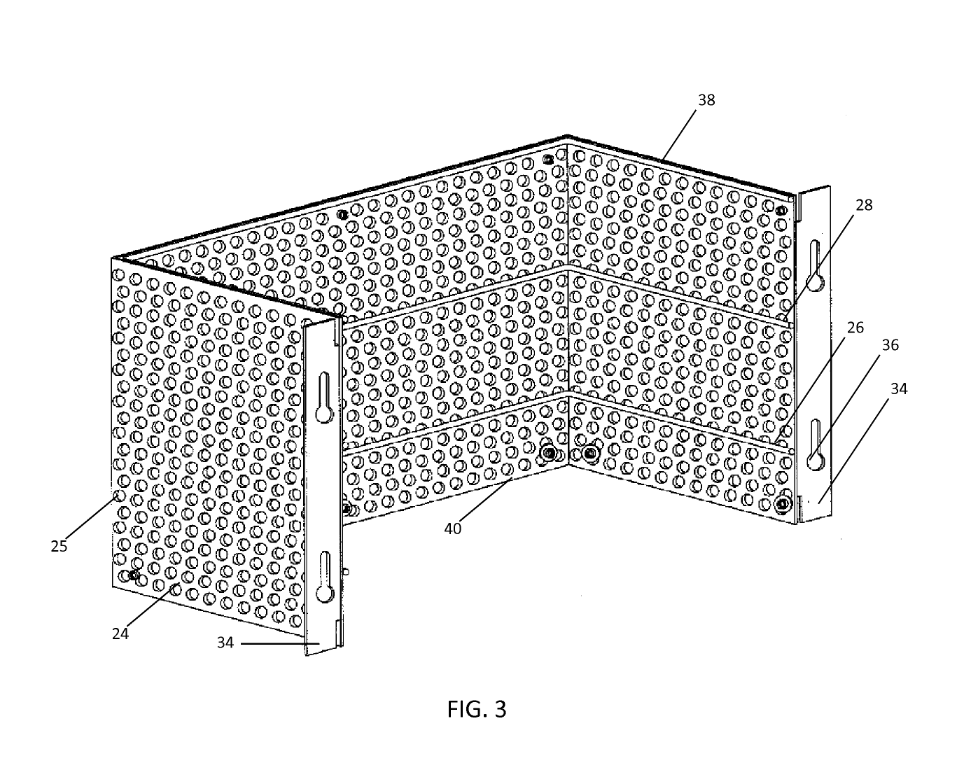

In an embodiment, as shown in FIG. 3, a plurality of support rods are employed to strengthen the catch basin insert and prevent the screen from being deformed by high water pressure and debris. In the first embodiment, a lower support rod 28 and an upper support rod 30, are coupled to the screen 24. The lower rod 26 and the upper rod 28 may be coupled to the screen 24 via spot welding. The lower rod 26 and the upper rod 28 may also be coupled to the screen 24 using fasteners or adhesives. Preferably, the lower rod 26 and the upper rod 28 are formed to be in a substantially cylindrical shape.

In an embodiment, the lower rod 26 and the upper rod 28 are formed from stainless steel, but as will be recognized by those of skill in the art, other materials suitable for a high corrosion environment of the catch basin may be used. The number of support rods may be varied depending on, for example, the dimensions and material of the screen, the number of holes in the screen, anticipated water pressure, and anticipated debris. For example, in some applications only one support rod may be used and in other applications three or more support rods may be used. Preferably the support rods 26, 28 are mounted substantially along the width of the screen. However, the support rods may be mounted in multiple orientations, such as substantially vertically, diagonally and in various combinations.

Mounting brackets 30, 32 are coupled to the ends of the screen. Each mounting bracket 30, 32 has an outwardly extending flange 34, the flange 34 is configured to sit against a wall of the catch basin. Each flange 34 has a plurality of mounting holes 36 which engage with posts or fasteners (not shown) in the wall of the catch basin to mount the catch basin insert 10 to the wall of the catch basin. Preferably, the mounting holes 36 are keyhole shaped, such that the post in the wall of the catch basin is introduced into a first portion of the keyhole having a large diameter and the mounting bracket 30, 32 is moved relative to the post such that the post then travels into a second portion of the keyhole having a smaller diameter to lock the catch basin screen 10 to the wall of the catch basin. The keyhole is advantageous in allowing for relatively quick, easy and toolless removal of the catch basin insert 10 by moving the catch basin insert 10 relative to the posts in the wall of the catch basin until the catch basin insert can be disengaged from the posts.

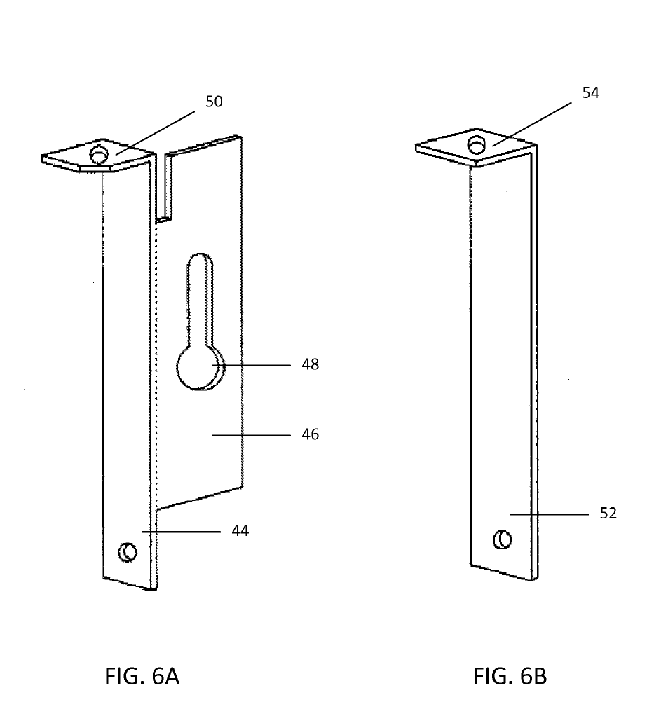

As shown in FIGS. 2 and 3, the screen has an upper edge 38 and a lower edge 40. As shown in FIGS. 2 and 6A, two side bypass support members 42 and 44 are coupled to the screen proximal to the ends and proximal to the upper edge 40. As with the mounting brackets 30, 32, each of the two side bypass support members 42, 44 has an outwardly extending flange 46, the flange 46 is configured to sit against a wall of the catch basin. Each flange 46 has at least one mounting hole 48 which engages with a post or fastener (not shown) in the wall of the catch basin to mount the catch basin insert 10 to the wall of the catch basin. Preferably, the mounting hole 48 is keyhole shaped. Each of the two side bypass support members 42, 44 have a top mounting flange 50.

As shown in FIGS. 2 and 6B, at least one additional bypass support member 52 is coupled to the screen 24 between the ends and proximal to the upper edge 38. Each bypass support members 52 has a top mounting flange 54. As will be appreciated by those of skill in the art, the number of bypass support members and the position of the bypass support members may be varied depending on, for example, the size of the screen, the anticipated amounts of water and debris. The two side bypass support members 42, 44 and the remaining bypass member(s) 52 are all coupled to the top 22.

The top 22 may be coupled to the two side bypass support members 42, 44 and the bypass support members 52 using a fastener 54 through the top 22 and the top mounting flange 50 of each of the two side bypass vertical members 42 and 44 and the top mounting flange 54 of the bypass members 52. Alternatively, the top assembly may be coupled to the two side bypass support members 42 and 44 and the front bypass support member 50 via spot welding or using an adhesive.

In an embodiment of the present invention as shown in FIGS. 2, 4, and 5, the top 22 comprises a top screen 56. Preferably, the top screen 56 is formed from stainless steel and has a plurality of holes 58. In an embodiment, the top screen 56 is formed from 14 gauge stainless steel with a plurality of 5 mm holes 58. The size, number and pattern of holes 58 may be altered based on the environment of the catch basin, including for example, the expected volume of water and the size of expected debris in the water.

The screen holes 36 and the top screen holes 58 permit storm water and ground water to flow therethrough. In the first embodiment, the screen holes 36 and the top screen holes 56 have a sufficiently small dimension to prevent many types of common environmental debris, trash, and pollutants from passing through the screen. Preferably, the screen holes 36 and the top screen holes 58 are circular. However, the screen holes 36 and the top screen holes 58 may have various other shapes.

According to an embodiment of the present invention, the top 22 has an access module consisting of an opening 60 and a door 62 rotatably mounted therein. In an embodiment, the door 62 has a top screen 64 and a frame 66. In an embodiment, the top screen 64 is welded to the frame 66. Alternatively, the top screen 64 may be coupled to the frame 64 using fasteners such as screws or an adhesive such as epoxy. Alternatively, the top screen 64 and frame 66 may be formed from a single piece of material. In an embodiment, the frame 66 is approximately rectangular and has a front 68, a rear 70 and two sides 72, 74. Each of the frame sides 72, 74 has a flange 76 proximal to the rear 70. Each flange 76 has a pivot pin 78 coupled thereto.

In an embodiment, the top opening 60 is approximately rectangular and is configured to fit the frame 66. The opening 60 has a front 80, a rear 82 and two sides 84, 86. Each of the sides 84, 86 have a flange 88 proximal to the rear 82. Each flange 88 has a pivot hole 90 for receiving the pivot pin 78. The pivot pin 78 and the pivot hole 90 allow for rotatably coupling the door 62 to the top 22.

The opening front 80 has at least one stop configured such that door 66 cannot rotate down inside of the body 20, even in response to severe pressure from water and debris. Optionally, each opening side 84, 86 also has at least one flange for limiting rotation of the door 62.

In an embodiment, the door frame front 68 has a plurality of protrusions 92 and the opening front 80 has a plurality of detents 94 such that when door 62 is closed within the opening 60, an increased friction fit is created to maintain the door 62 in a closed position. In an additional embodiment, the door frame 66 and the top 22 may have one or more holes and fasteners may be used to lock the door frame 66 to the remainder of the top 22 to maintain the door 62 in a closed position. In another embodiment, the door 62 may be fitted with a lock, such as a combination or key lock that allows the door 66 to be locked in a closed position. In an additional embodiment of the present invention, the door 62 may have a handle 96 attached thereto to assist in rotating the door 62 between a closed position and an open position.

In an embodiment, the pivot pins 78 are inserted through the pivot holes 90 in the opening sides 84, 86 and attached, such as through welding, to the door frame flanges 76. Preferably, the location of the pivot pins 78 and the pivot holes 90 in the frame 66 are configured such that the door 62 can be rotated more than 90 degrees relative to the remainder of the top 22 to an open position where the door 62 will remain in the open position without being held open by a user. This feature is particularly advantageous, because it allows a worker to use both hands to access the inside of the catch basin insert 10 without another device or assistance from another worker.

Preferably, all of the parts of the catch basin insert 10 are made from a corrosion resistant metal, such as stainless steel, to withstand the moisture, dirt and abrasion of debris of the catch basin environment. Preferably, the corrosion resistant material is strong enough to prevent the catch basin screen from being compromised by substantial water pressure and impact from debris. Those of skill in the art will recognize the different thicknesses of stainless steel and alternative materials may also be used.

The dimensions of the catch basin insert 10 are variable. The height, length, depth and bypass height may all be changed in response to environmental factors such as the dimensions of the catch basin, the amount of debris typically present, the amount of water typically present, and the frequency of cleaning. In an alternative embodiment of the present invention, the top 22 is connected to the screen 24 and there are no bypass support members.

The access module allows vertical access to the inside of the catch basin insert 10 for cleaning. Preferably all of the edges of the access module outer frame 60 and inner frame 62 are smooth to avoid damage to a cleanout hose. In an additional embodiment of the present invention, the top 22 may only comprise a screen with access to the body being had by a moveable door in screen 24.

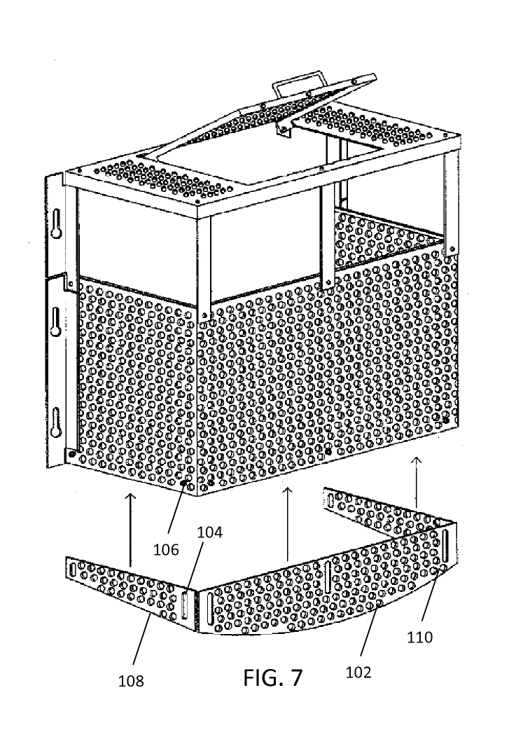

In an additional embodiment of the present invention, as shown in FIG. 7, the catch basin insert is intended for use in catch basins having an angled or rounded bottom. To accommodate angled or rounded catch basin bottoms, the catch basin insert is fitted with adjustable extensions 100 mounted proximal to the bottom edge 38 of the screen 24. As with the screen 24, the extensions 100 may have holes 102 sized to allow water but not debris to pass through.

The extensions 100 may be made from, for example, 12 gage stainless steel. As will be understood by those of skill in the art, other materials may be used for the extensions depending on the dimensions of the extensions, the shape of the catch basin, and the anticipated amounts of water and debris to which the catch basin insert is likely to be subjected. In a preferred embodiment, the extensions 100 each have a plurality of mounting slots 104 and the extensions 100 are adjustably proximal to the bottom edge 38 of the screen 24 using a plurality of fasteners 106, such as screws. The use of mounting slots 104 allows for the height of the extensions 100 relative to the bottom edge 38 to be varied to accommodate different catch basin dimensions without having to remanufacture the catch basin inserts. The screen 24 may also be fitted with a variety of differently sized extensions 100 to accommodate different catch basin dimensions. In an additional embodiment, one or more of the extensions 100 has an angled portion 108 or a rounded portion 110.

In an additional embodiment, rather than having a substantially U-shaped body 20 with a substantially rectangular 22 top, the body may be substantially hemi-cylindrical with a substantially semi-circular top 22. The top may have a substantially square or rectangular inner and outer frames for access to the inside of the catch basin insert 10. In an additional embodiment, the body 20 may be substantially L-shaped with a substantially rectangular top 22 for mounting on two walls, such as in a corner of a catch basin.

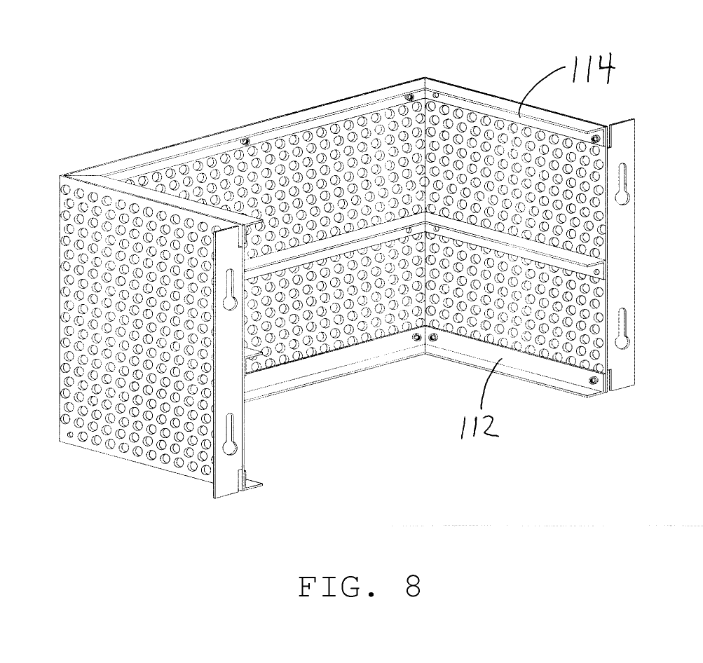

In an additional embodiment of the invention, as shown in FIG. 8, instead of a plurality of support rods employed to strengthen the catch basin insert and prevent the screen from being deformed by high water pressure and debris, a plurality of horizontal metal supports are used. In an embodiment, a lower horizontal support 112 and an upper horizontal support 114, are coupled to the screen 24. The lower horizontal support 112 and the upper horizontal support 114 may be coupled to the screen 24 via spot welding. The lower horizontal support 112 and the upper horizontal support 114 may also be coupled to the screen 24 using fasteners or adhesives. Preferably, the lower horizontal support 112 and the upper horizontal support 114 are formed from flat metal strips containing a bend to enhance the rigidity of the support. Preferably the bend is approximately 90 degrees.

In an embodiment, the lower horizontal support 112 and the upper horizontal support 114 are formed from 12 gauge stainless steel, but as will be recognized by those of skill in the art, other materials suitable for a high corrosion environment of the catch basin may be used. The number of horizontal supports may be varied depending on, for example, the dimensions and material of the screen, the number of holes in the screen, anticipated water pressure, and anticipated debris. For example, in some applications only one horizontal support may be used and in other applications three or more horizontal supports may be used. Preferably the horizontal supports 112, 114 are mounted substantially along the width of the screen.

There is disclosed in the above description and the drawings, a catch basin insert which fully and effectively overcomes the disadvantages associated with the prior art. However, it will be apparent that variations and modifications of the disclosed embodiments may be made without departing from the principles of the invention. The presentation of the preferred embodiments herein is offered by way of example only and not limitation, with a true scope and spirit of the invention being indicated by the following claims.

Any element in a claim that does not explicitly state “means” for performing a specified function or “step” for performing a specified function, should not be interpreted as a “means” or “step” clause as specified in 35 U.S.C. §112.

What is claimed is:

1. A screen system comprising;
a body comprising:
a screen having an upper edge, a lower edge and two side edges;
a plurality of support rods coupled to the screen;
mounting brackets coupled to the side edges of the screen;
a plurality of bypass support members coupled to the screen; and
a top coupled to the plurality of bypass support members.

2. The screen system of claim 1 wherein the mounting brackets each further comprise a flange, wherein the flange further comprises at least one mounting hole for mounting the screen system to the wall of a catch basin.

3. The screen system of claim 2 wherein the mounting holes are keyhole shaped.

4. The screen system of claim 2 wherein at least two of the bypass support members further comprise a flange, wherein the flange further comprises at least one mounting hole for mounting the screen system to the wall of a catch basin

5. The screen system of claim 1 wherein the top further comprises a screen.

6. The screen system of claim 1 wherein the top further comprises an opening and a door rotatably mounted therein, wherein the door is moveable between a closed position and an open position.

7. The screen system of claim 6 wherein the door may be rotated more than 90 degrees relative to the top.

8. The screen system of claim 7 wherein the door is configured to remain in the open position unless moved by hand.

9. The screen system of claim 6 wherein the door further comprises a lock to hold the door in the closed position.

10. The screen system of claim 6 wherein:
the door has a front, a rear and two sides, each door side further comprising a flange with a pivot pin coupled thereto;
the opening has a front, a rear and two sides, each opening side further comprising a flange with a pivot hole therein; and
wherein the pivot pins are mounted in the pivot holes to rotatably couple the door to the top.

11. The screen system of claim 10 wherein the top further comprises a stop for limiting rotation of the door relative to the top.

12. The screen system of claim 11 wherein the door front further comprises a plurality of protrusions and the front of the top opening has a plurality of detents, the protrusions and detents being configured to maintain the inner frame in a closed position.

13. The screen system of claim 1 further comprising a plurality of extensions moveably coupled to the screen, the extensions having a plurality of holes.

14. The screen system of claim 13 wherein at least one of the extensions has an angled portion and wherein the screen system is configured for placement in a catch basin having a sloping floor.

15. The screen system of claim 13 wherein at least one of the extensions has a rounded portion and wherein the screen system is configured for placement in a catch basin having a rounded floor.

16. The screen system of claim 1 wherein the body is substantially U-shaped and has at least four bypass support members.

17. The screen system of claim 1 wherein the body is substantially L-shaped and has at least three bypass support members.

18. A screen system comprising;
a substantially U-shaped body further comprising:
a screen having an upper edge, a lower edge and two side edges;
a first support rod coupled to the screen proximal to the lower edge;
a second support rod coupled to the screen proximal to the upper edge;
a plurality of mounting brackets coupled the screen proximal to the two side edges;
a plurality of bypass support members coupled to the screen; and
a top coupled to the plurality of bypass support members, the top further comprising:
an opening having a front, a rear and two sides, each opening side further comprising a flange with a pivot hole therein; and
a door rotatably mounted in the opening, the door being moveable between a closed position and an open position and further comprising a front, a rear and two sides, each door side further comprising a flange with a pivot pin coupled thereto; and
wherein the pivot pins are mounted in the pivot holes to rotatably couple the door to the top.

19. The screen system of claim 18 further comprising a plurality of extensions moveably coupled to the screen, the extensions having a plurality of holes; and at least one of the extensions having an angled portion or a rounded portion such that the screen system is configured for placement in a catch basin having a sloping or rounded floor.

20. A screen system comprising;
a body comprising:
a screen having an upper edge, a lower edge and two side edges;
a plurality of horizontal supports coupled to the screen;
mounting brackets coupled to the side edges of the screen;
a plurality of bypass support members coupled to the screen; and
a top coupled to the plurality of bypass support members.
